(19) United States
(12) Patent Application Publication
(10) Pub. No.: US 2009/0159448 A1
(43) Pub. Date: Jun. 25, 2009

(54) ELECTROLYSIS DEVICE, METHOD, AND WASHER USING SUCH A DEVICE

(75) Inventors: Wei Cai, Shanghai (CN); Chang Wei, Niskayuna, NY (US); Hai Yang, Shanghai (CN); Su Lu, Shanghai (CN); Rihua Xiong, Shanghai (CN); Bing Zhang, Shanghai (CN); Qunjian Huang, Shanghai (CN); Zijun Xia, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/123,521

(22) Filed: May 20, 2008

(30) Foreign Application Priority Data
Dec. 25, 2007 (CN) 2007103015649

(51) Int. Cl. B01D 61/00; C25B 9/08

(52) U.S. Cl. 204/537; 204/252

(57) ABSTRACT

An electrolysis device, for producing alkaline water from water, includes an electrolysis vessel, a pair of high porous electrodes arranged in the electrolysis vessel, and a cell unit arranged between the positive and negative electrodes. The pair of high porous electrodes respectively serve as a positive electrode and a negative electrode. The cell unit includes a bipolar membrane element and at least one cation exchangeable membrane. The bipolar membrane element has a cation exchangeable side and an anion exchangeable side. The cation exchangeable side is closer to the negative electrode than the anion exchangeable side. The cation exchangeable membrane is arranged between the anion exchangeable side of the bipolar membrane element and the positive electrode, so as to define an alkalic chamber between the bipolar membrane element and the cation exchangeable membrane.

### BACKGROUND

Embodiments of the present invention relate to electrodialysis devices and associated methods for producing ionized water which is suitable for washing. More specifically, embodiments of the present invention relate to washers, such as laundry machines, dish washers and the like, having electrodialysis devices.

Traditional washers, such as but not limited to laundry machines, usually use detergents to wash. However, the detergents may remain in the washed laundry which may possibly cause sensitivities in certain individuals. In order to prevent the detergent from remaining in the laundry, the laundry must be repeatedly rinsed using a large amount of water, thereby resulting in a great waste. Moreover, the water expelled from the washer after the laundry process contains some detergents which may exceed environmental and municipal regulations.

In order to address the above-recognized problems, electrolysis devices are used in detergentless washers to produce alkaline water with cleaning properties. The conventional electrolysis device usually includes a plurality of anode and cathode units alternately arranged. The anode and cathode units are separated from each other by a plurality of ion exchangeable membranes. An acidic chamber and an alkalic chamber are respectively formed between the membranes. However, the conventional electrolysis devices generate hydroxyls based on water hydrolysis reactions, which involves hydrogen and chlorine gas generation. This gas generation is undesired for home appliances.

### SUMMARY

An aspect of the invention resides in an electrolysis device for producing alkaline water from water. The electrolysis device includes an electrolysis vessel, a pair of high porous electrodes arranged in the electrolysis vessel, and a cell unit arranged between the positive and negative electrodes. The pair of high porous electrodes respectively serve as a positive electrode and a negative electrode. The cell unit includes a bipolar membrane element and at least one cation exchangeable membrane. The bipolar membrane element has a cation exchangeable side and an anion exchangeable side. The cation exchangeable side is closer to the negative electrode than the anion exchangeable side. The cation exchangeable membrane is arranged between the anion exchangeable side of the bipolar membrane element and the positive electrode, so as to define an alkalic chamber between the bipolar membrane element and the cation exchangeable membrane.

Another aspect of the invention resides in a washer. The washer includes an electrolysis device and a washing container for storing water for washing. The electrolysis device includes a bipolar membrane element and at least one cation exchangeable membrane. The bipolar membrane element includes a cation exchangeable side and an anion exchangeable side. The cation exchangeable side is closer to the negative electrode than the anion exchangeable side. The at least one cation exchangeable membrane is between the anion exchangeable side of the bipolar membrane element and the positive electrode, so as to define an alkalic chamber between the bipolar membrane element and the cation exchangeable membrane and an acidic chamber adjacent to a cation exchangeable side of the bipolar membrane element. The electrolysis device further includes an acidic container communicating with the acidic chamber for storing the acidic water generated. The washing container receives alkalic water generated by the electrolysis device for cleaning purpose.

Still another aspect of the invention resides in an electrolyzing method for producing alkalic water from water. The method includes the steps of passing a direct current through a pair of high porous electrodes in a vessel so as to energize the pair of high porous electrodes respectively as a positive and a negative electrode. Supplying a feed water into the vessel, a bipolar membrane in the vessel splits the water into H⁺ and OH⁻. The generated OH⁻ is prevented from moving further by a cation exchangeable membrane, so as to define an alkalic chamber between the bipolar membrane element and the cation exchangeable membrane. Remove the alkalic water out of the vessel.

These and other advantages and features will be more readily understood from the following detailed description of preferred embodiments of the invention that is provided in connection with the accompanying drawings.

### BRIEF DESCRIPTION OF DRAWINGS

FIG. 1 schematically illustrates a washer having an electrolysis device.

FIG. 2 illustrates the electrolysis device according to a first embodiment.

FIG. 3 illustrates the electrolysis device according to a second embodiment of the invention.

FIG. 4 illustrates the electrolysis device according to a third embodiment of the invention.

FIG. 5 illustrates the electrolysis device according to a fourth embodiment of the invention.

### DETAILED DESCRIPTION OF PREFERRED EMBODIMENTS

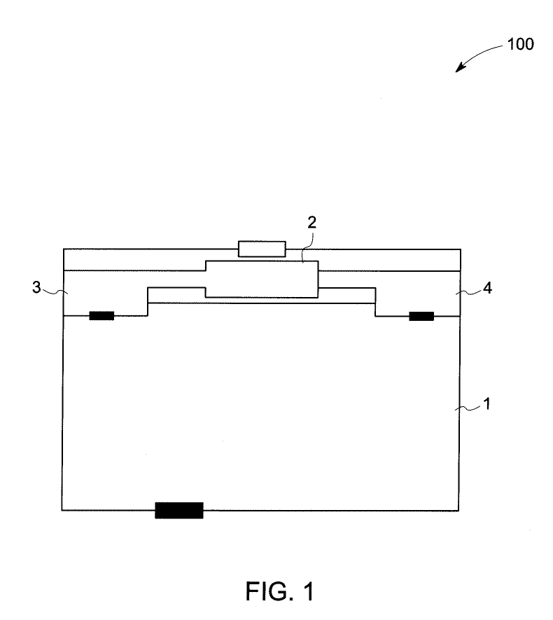

FIG. 1 illustrates an exemplary washer 100 for laundry. The exemplary washer 100 includes a washing container 1 for storing water and for washing the laundry, and an electrolysis device 2 for generating acidic water and alkalic water. The alkalic water generated by the electrolysis device 2 flows into the washing container 1 for cleaning the laundry. In certain embodiments, the washer 100 also includes an acidic water container 3 and an alkalic water container 4 for respectively storing the acidic water and alkalic water generated by the electrolysis device 2 before a washing process.

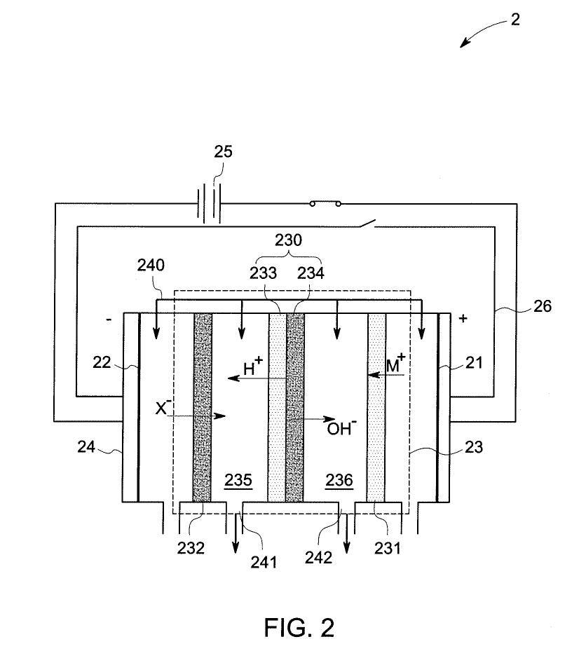

Referring to FIG. 2, a first embodiment of the electrolysis device 2 for producing acidic water and alkalic water includes a pair of high porous electrodes respectively acting as a positive electrode 21 and a negative electrode 22, at least one cell unit 23 between the positive and negative electrodes 21, 22, and a vessel 24 for housing the electrodes 21, 22 and the cell unit 23 therein. The positive and negative electrodes 21, 22 respectively connect with an anode and a cathode of a DC power supply 25. The vessel 24 includes at least one inlet 240 for inducing a feed stream to flow through the electrolysis device 2, and an acidic outlet 241 and an alkalic outlet 242 respectively for alkalic water and acidic water generated to flow into the alkalic and acidic water container 3, 4. The cell unit 23 includes at least one alkalic chamber and at least one acidic chamber defined between ion exchangeable membranes, which will be discussed in detail later through FIGS. 2-5.

The cell unit 23 of the electrolysis device 2 according to the first embodiment, shown in FIG. 2, comprises a bipolar membrane element 230, a cation exchangeable membrane 231, and an anion exchangeable membrane 232. The bipolar membrane element 230 has a cation exchangeable side 233 and an anion exchangeable side 234, and is used as a water splitter. The cation exchangeable side 233 of the bipolar membrane element 230 is closer to the negative electrode 21 than the anion exchangeable membrane 232. The cation exchangeable membrane 231 is arranged between the anion exchangeable side 234 and the positive electrode 21. The anion exchangeable membrane 232 is arranged between the cation exchangeable side 233 and the negative electrode 22. A direct current from the power supply 25 flows through the bipolar membrane element 230 causing the water to split with OH⁻ ions being produced on the anion exchangeable side 234 and a corresponding number of H⁺ ions being produced on the cation exchangeable side 233 of the bipolar membrane element 230. The generated OH⁻ and H+ions are prevented from moving further by the cation exchangeable membrane 231 and the anion exchangeable membrane 232, respectively. Some dissociated salt anions (M⁺), such as Ca⁺, Na⁺, Mg⁺ in the water moves toward the negative electrode. Some dissociated anions (X⁻), such as Cl⁻, HCO₃⁻, CO₃²⁻, SO₄²⁻, NO₃⁻ in the water move toward the positive electrode. Thus an alkalic chamber 236 is defined between the bipolar membrane element 230 and the cation exchangeable membrane 231, and an acidic chamber 235 is defined between the bipolar membrane element 230 and the anion exchangeable membrane 232. The pH of the water in the alkalic chamber 236 is about 8-14.

The bipolar membrane element 230 has a water splitting feature to split water directly into H⁺ and OH⁻. The application of the bipolar membrane element 230 greatly improves the efficiency of the electrolysis device 2 for producing alkalic water and acidic water from the water. The bipolar membrane element 230 may be a bipolar membrane which includes a cation exchangeable layer and an anion exchangeable layer, or a bipolar module formed by a combination of anion and cation exchangeable membranes which functions as a bipolar membrane. The cation exchangeable side 233 and the anion exchangeable 234 side of the bipolar membrane element 23 has a water diffusion percentage of 0.1-10%.

In one embodiment, the high porous positive and negative electrodes 21, 22 are made from carbon materials selected from any of activated carbon, carbon black, carbon nanotubes, graphite, carbon fiber, carbon cloth, carbon aerogel, or combination thereof. Surface area of the carbon material is in a range of from about 500 to 2000 square meters per gramme as measured by nitrogen adsorption BET method. The high porous positive and negative electrodes 21, 22 each has a shape, size or configuration that is a plate, a block, a cylinder, or a sheet.

It is known in the art that a threshold voltage of water hydrolysis is about 1.23 v. After this threshold is reached, there will be reactions respectively adjacent to the positive and negative electrodes 21, 22 as follows:

2H₂O+2e→2OH⁻+H₂ (at the negative electrode 22)

2H₂O→4H⁺+O₂+4e; (at the positive electrode 21)

Moreover, Cl₂ will be generated at the negative electrode 22 if the voltage reaches about 1.36 v for the reaction:

2Cl⁻2e→Cl₂

The high porous electrodes 21, 22 have a feature that the voltage there between increases gradually, and thus there is a time duration t before the threshold voltage is reached. During the time duration t, the bipolar membrane element 230 splits water into H⁺ and OH⁻, and there will be no gases, including H², O² and Cl² generated at the positive and negative electrodes 21, 22, respectively.

In certain embodiments, a voltage sensor (not shown) is used for real-timely sensing of the voltage between the positive and negative electrodes 21, 22. Once the voltage has reached a set value, which is lower than the water hydrolysis threshold voltage, for example 1.20 v, the electrolyzing process stops and thus no gas or very little gas will be generated.

In other embodiments, the time duration t required for the voltage between the positive and negative electrodes 21, 22 to reach said threshold voltage can be estimated based on the following relationship:

Q=It=CV

where Q is the electrical charge accumulated onto the porous electrode pair (positive and negative electrodes) 21, 22 during the time duration t; I is the charging current; C is the capacitance of the electrode pair 21, 22, which is determined by the loading and specific capacitance of the active material; V is the capacitive voltage buildup of the electrode pair, which is usually controlled within certain range, e.g. 1.2V. For example, for an electrode pair with a capacitance of 200 Faraday under a charging current of 0.2 Ampere, the time duration time is up to 20 minutes (200 Faraday*1.2 Volt/0.2 Ampere=1200 second).

By calculating the time duration t, the time for an electrolyzing process is controlled to be less than the time duration t, thereby decreasing or eliminating any gas generated during the electrolyzing process.

If the amount of alkalic water generated during one electrolyzing process is not enough or a pH of the generated alkalic water is not high enough, another electrolyzing process can be performed after the porous positive and negative electrodes 21, 22 are recovered. In certain embodiments, a pH sensor (not shown) for measuring the pH of the generated alkalic water is used for real-time detection of the pH value of the water in the alkalic chamber 236.

In certain embodiments, before a pH of the alkalic chamber 236 reaches a desired value, for example 11, the water therein returns back to the vessel as a feed into the alkalic chamber for further electrolyzing.

In certain embodiments, a short-circuiting line 26 is used for short-circuiting the positive and negative high porous electrodes 21, 22 for recovering of the electrodes 21, 22 after the electrolyzing process.

The water typically includes some CO₂, and the CO₂ consumes some OH⁻ generated from the electrolysis device. This can be disadvantageous for improving the electrolyzing efficiency, because of the following reactions:

H₂O+CO₂→H₂CO₃

H₂CO₃+OH⁻→HCO₃⁻+H₂O

HCO₃⁻+OH⁻→CO₃²⁻+H₂O

For solving this problem, in certain embodiments, a CO₂ absorber can be used at the inlet of the electrolysis device for absorbing the CO₂ in the water before it flows into the electrolysis device. A proper CO₂ absorber may include, but is not limited to, polyethylenimine (PEI), Triethanolamine (TEA), Amidine derivatives, Phenethyl piperidine, PLPPZ, 4Aminopiperidine (4AP), 4Trimethylenedipiperidine (4TMDP), 4Aminomethylpiperidine (4AMP), and Carbon Fiber Composite Molecular Sieve (CFCMS).

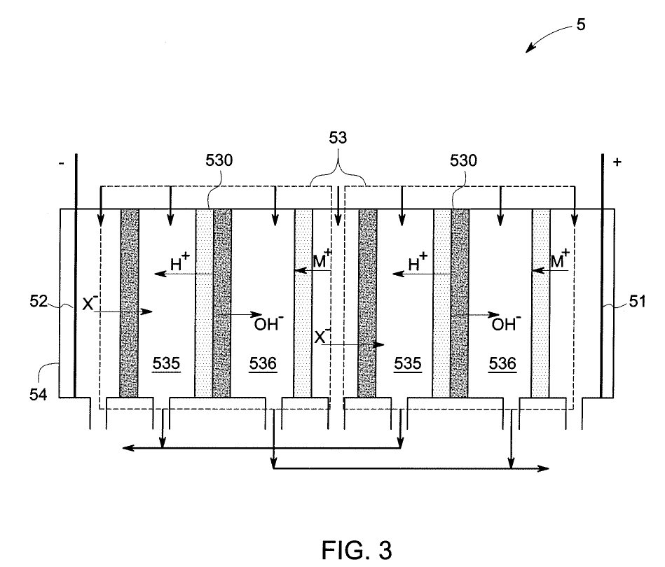

FIG. 3 illustrates a second embodiment of the electrolysis device 5 which utilizes two cell units 53 between a high porous positive electrode 51 and a high porous negative electrode 52. Each cell unit 53 may have the same configuration as the cell unit 23 of the first embodiment shown in FIG. 2. More specifically, two alkalic chambers 536 and two acidic chambers 535 may be defined adjacent to the bipolar membrane elements 530. The electrolysis device 5 may also include several cell units 53 as desired in a vessel 54.

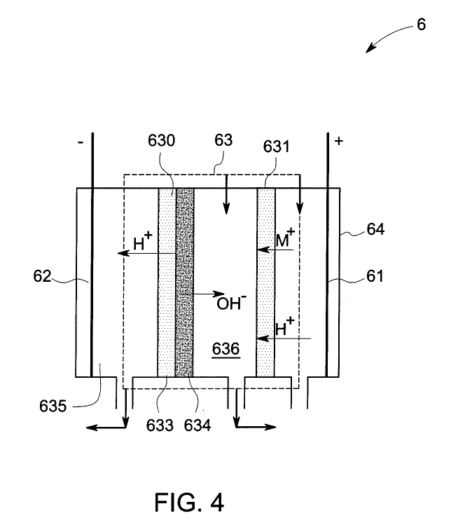

FIG. 4 illustrates a third embodiment of the electrolysis device 6 which includes a cell unit 63 between a high porous positive and negative electrodes 61, 62. The cell unit 63 includes a bipolar membrane element 630 and an anion exchangeable membrane 631. The bipolar membrane element 630 includes a cation exchangeable side 633 and an anion exchangeable side 634. The anion exchangeable side 634 is closer to the positive electrode 61 than the cation exchangeable side 633, and the cation exchangeable membrane 631 is placed adjacent to the anion exchangeable side 634 of the bipolar membrane element 630. An alkalic chamber 636 is defined between the bipolar membrane element 630 and the cation exchangeable membrane 631. Since the H+ions generated by the bipolar membrane element 630 are partially absorbed by the high porous negative electrode 62, the chamber between the negative electrode 62 and the bipolar membrane element 630 is a weak-acidic chamber 635. The electrolysis device 6 may include several cell units 63 in a vessel 64.

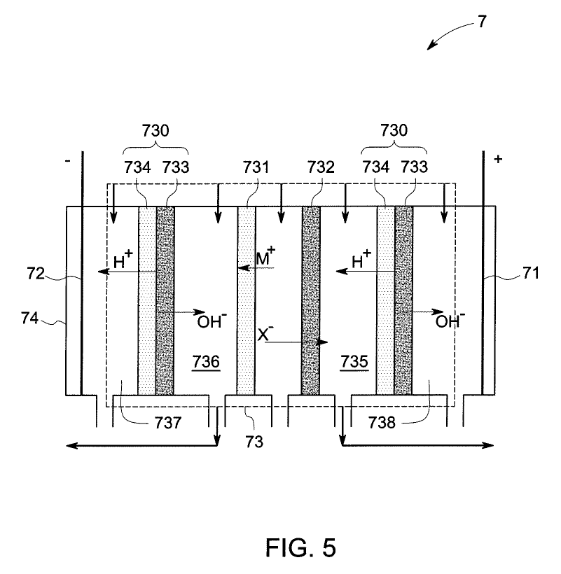

FIG. 5 illustrates a fourth embodiment of the electrolysis device 7 which includes a cell unit 73 between a high porous positive and negative electrodes 71, 72. The cell unit 73 includes two bipolar membrane elements 730, a cation exchangeable membrane 731, and an anion exchangeable membrane 732. Anion exchangeable sides 734 of the two bipolar membranes 730 are closer to the positive electrode 71 than the corresponding cation exchangeable sides 733. The cation and anion exchangeable membranes 731, 732 are arranged between the two bipolar membrane elements 730 in such a manner that the anion exchangeable membrane 732 is close to the cation exchangeable side 732 of one bipolar membrane, and the cation exchangeable membrane 731 is close to the anion exchangeable side 733 of the other bipolar membrane element 730. Thus an alkalic chamber 736, an acidic chamber 735, a weak-acidic chamber 737, and a weak-alkalic chamber 738 are so defined as shown in FIG. 5.

A washing process for laundry may generally include a cleaning process, a rinsing process, and a drying process. At the cleaning process, the water is induced into the electrolysis device 2 for generating enough alkalic water having a pH of about 9-13. The alkalic water then flows into the washing container 1, and the water flow into the washing container 1 to mix with the alkalic water. The mixed water for washing may have a pH of about 9-11.

In certain embodiments, the acidic water generated by the electrolysis device is stored in the acidic water container 3. At the rinsing process following the cleaning process, the acidic water may flow into the washing container 1 for sterilization purpose. In certain embodiments, the acidic water may also flow through the electrolysis device 2 after the electrolyzing process is finished so as to dissolve scaling, such as CaCO₃, on the membranes.

While only certain features of the invention have been illustrated and described herein, many modifications and changes will occur to those skilled in the art. For example, embodiments of the invention are not limited to the exemplary laundry machines, but also apply to, for example, washers for dishes, sterilizing medical instruments, washing vegetables, meat, fish and etc. It is, therefore, to be understood that the appended claims are intended to cover all such modifications and changes as fall within the true spirit of the invention.

1. An electrolysis device for producing alkaline water from water includes:
an electrolysis vessel;
a pair of high porous electrodes arranged in the electrolysis vessel, the pair of high porous electrodes respectively serving as a positive electrode and a negative electrode; and
a cell unit arranged between the positive and negative electrodes, the cell unit comprising a bipolar membrane element and at least one cation exchangeable membrane, the bipolar membrane element having a cation exchangeable side and an anion exchangeable side, the cation exchangeable side being closer to the negative electrode than the anion exchangeable side, said at least one cation exchangeable membrane being arranged between the anion exchangeable side of the bipolar membrane element and the positive electrode, so as to define an alkalic chamber between the bipolar membrane element and the cation exchangeable membrane.

2. The electrolysis device according to claim 1 further including an anion exchangeable membrane between the negative electrode and the cation exchangeable side of the bipolar membrane element, an acidic chamber being defined between the anion exchangeable membrane and the bipolar membrane element.

3. The electrolysis device according to claim 1, wherein a pH of the water in the alkalic chamber is about 8-14.

4. The electrolysis device according to claim 1, wherein the bipolar membrane element includes a cation exchangeable layer and an anion exchangeable layer closely contacts with the cation exchangeable layer.

5. The electrolysis device according to claim 1, wherein the cation exchangeable side and the anion exchangeable side of the bipolar membrane element has a water diffusion percentage of 0.1-10%.

6. The electrolysis device according to claim 1, wherein at least one of the pair of high porous positive and negative electrodes has a shape, size or configuration that is a plate, a block, a cylinder, or a sheet.

7. The electrolysis device according to claim 1, wherein at least one of the pair of high porous positive and negative electrodes is made from carbon material selected from any of activated carbon, carbon black, carbon nanotubes, graphite, carbon fiber, carbon cloth, carbon aerogel, or combinations thereof.

8. The electrolysis device according to claim 7, wherein a surface area of the carbon material is in a range of from about 500 to 2000 square meters per gramme as measured by nitrogen adsorption BET method.

9. The electrolysis device according to claim 1 further including a plurality of cell units between the high porous positive and negative electrodes.

10. The electrolysis device according to claim 1 further including a short circuiting line operatively short circuiting the pair of high porous electrodes after an electrolysis process.

11. The electrolysis device according to claim 1 further including a voltage sensor for detecting real-time voltage between the high porous positive and negative electrodes.

12. A washer comprising:
an electrolysis device, the electrolysis device including:
an electrolysis vessel;
a pair of electrodes respectively as a positive electrode and a negative electrode, the positive and negative electrodes being arranged in the electrolysis vessel; and
a bipolar membrane element and at least one cation exchangeable membrane, the bipolar membrane element having a cation exchangeable side and an anion exchangeable side, the cation exchangeable side being closer to the negative electrode than the anion exchangeable side, said at least one cation exchangeable membrane being arranged between the anion exchangeable side of the bipolar membrane element and the positive electrode, so as to define an alkalic chamber between the bipolar membrane element and the cation exchangeable membrane and an acidic chamber adjacent to a cation exchangeable side of the bipolar membrane element;
an acidic container communicating with the acidic chamber for storing the acidic water generated; and
a washing container for storing water for washing, the washing container receiving alkalic water generated by the electrolysis device for cleaning purpose.

13. The washer according to claim 12, wherein a pH of the water in the washing container for cleaning is 9-11.

14. The washer according to claim 12 further comprising an alkalic container communicating with the first and second alkalic chambers.

15. The washer according to claim 12 further including a pH sensor for sensing pH of the water in the washing container.

16. An electrolyzing method for producing alkalic water from water, comprises:
passing a direct current through a pair of high porous electrodes in a vessel, so as to energize the pair of high porous electrodes respectively as a positive and a negative electrodes,
supplying a feed water into the vessel, a bipolar membrane in the vessel splitting the water into H⁺ and OH⁻, the generated OH⁻ being prevented from moving further by a cation exchangeable membrane, so as to define an alkalic chamber between the bipolar membrane element and the cation exchangeable membrane; and
removing the alkalic water out of the vessel.

17. The electrolyzing method according to claim 16, wherein the alkalic water removed from the alkalic chamber returns to the vessel as the feed water into the alkalic chamber before the generated alkalic water reaches a desired pH value.

18. The electrolyzing method according to claim 16, further comprising sensing a real-time voltage of the voltage between the high porous positive and negative electrodes.

19. The electrolyzing method according to claim 16, further comprising calculating a time duration t that a voltage between the high porous positive and negative electrodes reaches a threshold voltage that the feed water begins to hydrolyze.

20. The electrolyzing method according to claim 19, further comprising stopping the electrolyzing process before the time duration t is reached, and recovering the high porous positive and negative electrodes.

21. The electrolyzing method according to claim 16 further comprising absorbing the CO₂ in the water before the water is introduced into the vessel.

22. The electrolyzing method according to claim 17, wherein absorbing the CO₂ in the water comprises selecting a CO₂ absorber from any of polyethylenimine (PEI), Triethanolamine (TEA), Amidine derivatives, Phenethyl piperidine, PLPPZ, 4Aminopiperidine (4AP), 4Trimethylenedipiperidine (4TMDP), 4Aminomethylpiperidine (4AMP), and Carbon Fiber Composite Molecular Sieve (CFCMS).
